(19) United States
(12) Patent Application Publication
(10) Pub. No.: US 2026/0051153 A1
(43) Pub. Date: Feb. 19, 2026

(54) METHOD EXECUTED BY ELECTRONIC DEVICE, ELECTRONIC DEVICE, STORAGE MEDIUM AND PROGRAM PRODUCT

(71) Applicant: SAMSUNG ELECTRONICS CO., LTD., Suwon-si (KR)

(72) Inventors: Hanchao JIA, Beijing (CN); Yingying JIANG, Beijing (CN); Xiaobing WANG, Beijing (CN); Peng HAO, Beijing (CN)

(73) Assignee: SAMSUNG ELECTRONICS CO., LTD., Suwon-si (KR)

(21) Appl. No.: 19/361,823

(22) Filed: Oct. 17, 2025

Related U.S. Application Data
(63) Continuation of application No. PCT/KR2025/008200, filed on Jun. 13, 2025.

(30) Foreign Application Priority Data
Aug. 14, 2024 (CN) 202411117566.2

(51) Int. Cl. G06V 10/77; G06F 16/535; G06F 16/583; G06F 40/284; G06F 40/30; G06V 10/26; G06V 10/54

(52) U.S. Cl. CPC G06V 10/77; G06F 16/535; G06F 16/5862; G06F 40/284; G06F 40/30; G06V 10/26; G06V 10/54

(57) ABSTRACT

A method executed by an electronic device includes, extracting a first text feature from a first text input by a user, extracting, from a first image input by the user, a first semantic feature of a first region related to the first text; generating a second semantic feature based on the first text feature and the first semantic feature; and obtaining an image from a candidate image set based on the second semantic feature and a first texture feature of the first region.

### CROSS-REFERENCE TO RELATED APPLICATIONS

This application is a by-pass continuation application of International Application No. PCT/KR2025/008200, filed on Jun. 13, 2025, which is based on and claims priority to Chinese Patent Application No. 202411117566.2, filed on Aug. 14, 2024, with the China National Intellectual Property Administration, the disclosures of which are incorporated by reference herein in their entireties.

### BACKGROUND

### 1. Field

The disclosure relates to the technical field of image retrieval, and in particular to a method executed by an electronic device, an electronic device, a storage medium and a program product.

### 2. Description of Related Art

In recent years, with the development of deep learning technology, image retrieval technology has attracted increasingly more attention. The use of multi-modal image retrieval, for example, has provided convenience. Inputs of the multi-modal image retrieval can be description text, a reference image, or the like, and such models seek to match a target image from a candidate image set by using multi-modal understanding technologies.

However, existing solutions may be deficient in retrieval accuracy.

### SUMMARY

According to an aspect of the disclosure, a method executed by an electronic device includes, extracting a first text feature from a first text input by a user; extracting, from a first image input by the user, a first semantic feature of a first region related to the first text; generating a second semantic feature based on the first text feature and the first semantic feature; and obtaining an image from a candidate image set based on the second semantic feature and a first texture feature of the first region.

The method may further include determining at least one first heat map corresponding to the first image; different first heat maps may correspond to different regions in the first image, and the different regions may correspond to different image feature tokens; obtaining a second heat map based on a second text feature corresponding to the first region and the at least one first heat map; the second heat map may correspond to the first region; extracting a second texture feature of the first image; and obtaining the first texture feature of the first region based on the second texture feature and the second heat map.

The obtaining the second heat map may include determining a plurality of image feature tokens for the first image corresponding to a plurality of different regions in the first image; obtaining a first attention result based on the plurality of image feature tokens and the first text feature via a first cross-attention network; a first weight of the first cross-attention network may correspond to the first attention result and may indicate a first plurality of relationships between the plurality of image feature tokens and a user intent; obtaining a second attention result based on the first attention result and the second text feature via a second cross-attention network; a second weight of the second cross-attention network may correspond to the second attention result and may indicate a second plurality of relationships between the plurality of image feature tokens and the second text feature; and fusing the at least one first heat map based on at least one from among the first weight and the second weight to obtain the second heat map.

The fusing the at least one first heat map may include enhancing the at least one first heat map based on at least one of the first weight or the second weight to obtain at least one third heat map that is enhanced; determining a plurality of weights corresponding to the plurality of image feature tokens based on the second attention result; and fusing the at least one third heat map based on the plurality of weights to obtain the second heat map.

The extracting the first semantic feature may include fusing the plurality of image feature tokens based on the plurality of weights to obtain the first semantic feature.

The generating the second semantic feature may include obtaining a third semantic feature of the first region based on the first semantic feature and a third text feature corresponding to a target image; and generating the second semantic feature based on the first text feature and the third semantic feature.

The obtaining the third semantic feature may include obtaining a third attention result based on the first semantic feature and the third text feature via a third cross-attention network; and obtaining the third semantic feature of the first region based on the third attention result.

The extracting the first text feature from the first text input may include performing token projection on the first semantic feature to obtain a second text; and obtaining the first text feature based on the first text and the second text via a text encoder.

The at least one of the first semantic feature or the first texture feature may be determined based on a second text feature corresponding to the first region, and the method may further include determining at least one of the second text feature or the third text feature, based on the first image and the first text.

The determining the second text feature may include determining a fourth semantic feature corresponding to the first image and at least one image feature token corresponding to the first image; different image feature tokens may indicate semantic features of different regions in the first image; determining at least one text feature token corresponding to the first text; and determining the second text feature based on the at least one text feature token, the fourth semantic feature, and the at least one image feature token.

The determining the second text feature based on the at least one text feature token, the fourth semantic feature and the at least one image feature token may include obtaining a first feature based on the at least one text feature token and the fourth semantic feature via a fourth cross-attention network, the first feature including user intent information; obtaining a second feature and a third feature based on the first feature and the at least one image feature token via a fifth cross-attention network, the second feature being in the at least one image feature token and relating to the first feature, the third feature being in the at least one image feature token and not relating to the first feature or having a weaker relationship to the first feature than the second feature; and determining the second text feature based on the second feature and the third feature.

The obtaining the first feature may include acquiring at least one of a first query vector for generating the second text feature or a second query vector for generating the third text feature; obtaining a text fusion feature via a self-attention network based on at least one of the first query vector or the second query vector, and the at least one text feature token; and obtaining the first feature based on the text fusion feature and the fourth semantic feature via the fourth cross-attention network.

The determining the plurality of image feature tokens may include determining a first plurality of image feature tokens corresponding to the first image; determining a second plurality of image feature tokens corresponding to a plurality of second images; and processing the first plurality of image feature tokens based on the second plurality of image feature tokens to obtain the plurality of image feature tokens.

The processing the first plurality of image feature tokens may include determining at least one first relationship between the first plurality of image feature tokens and the second plurality of image feature tokens; determining at least one text feature token corresponding to the first text, and determining at least one second relationship between the at least one text feature token and the second plurality of image feature tokens; and processing the first plurality of image feature tokens based on the at least one first relationship, the at least one second relationship, and the second plurality of image feature tokens to obtain a first plurality of processed image feature tokens corresponding to the first image.

According to an aspect of the disclosure, an electronic device includes, memory storing instructions; and, at least one processor, wherein the instructions, when executed by the at least one processor, cause the electronic device to extract a first text feature from a first text input by a user; extract, from a first image input by the user, a first semantic feature of a first region related to the first text; generate a second semantic feature based on the first text feature and the first semantic feature; and obtaining an image from a candidate image set based on the second semantic feature and a first texture feature of the first region.

The instructions, when executed by the at least one processor, may cause the electronic device to determine at least one first heat map corresponding to the first image, different first heat maps concerning different regions in the first image, the different regions corresponding to different image feature tokens; obtain a second heat map based on a second text feature corresponding to the first region and the at least one first heat map, the second heat map concerning the first region; extract a second texture feature of the first image; and obtain the first texture feature of the first region based on the second texture feature and the second heat map.

The instructions, when executed by the at least one processor, may cause the electronic device to determine a plurality of image feature tokens for the first image corresponding to a plurality of different regions in the first image; obtain a first attention result based on the plurality of image feature tokens and the first text feature via a first cross-attention network, a first weight of the first cross-attention network corresponding to the first attention result and indicating a first plurality of relationships between the plurality of image feature tokens and a user intent; obtain a second attention result based on the first attention result and the second text feature via a second cross-attention network, a second weight of the second cross-attention network corresponding to the second attention result and indicating a second plurality of relationships between the plurality of image feature tokens and the second text feature; and fuse the at least one first heat map based on at least one from among the first weight and the second weight to obtain the second heat map.

The instructions, when executed by the at least one processor, may cause the electronic device to enhance the at least one first heat map based on at least one of the first weight or the second weight to obtain at least one third heat map that is enhanced; determine a plurality of weights corresponding to the plurality of image feature tokens based on the second attention result; and fuse the at least one third heat map based on the plurality of weights to obtain the second heat map.

The instructions, when executed by the at least one processor, may cause the electronic device to fuse the plurality of image feature tokens based on the plurality of weights to obtain the first semantic feature.

According to an aspect of the disclosure, a non-transitory computer-readable recording medium having instructions recorded thereon, that, when executed by one or more processors, cause the one or more processors to extract a first text feature from a first text input by a user; extract, from a first image input by the user, a first semantic feature of a first region related to the first text; generate a second semantic feature based on the first text feature and the first semantic feature; and obtaining an image from a candidate image set based on the second semantic feature and a first texture feature of the first region.

### BRIEF DESCRIPTION OF THE DRAWINGS

The above and other aspects, features, and advantages of certain embodiments are more apparent from the following description taken in conjunction with the accompanying drawings, in which:

FIG. 1 is a schematic flowchart of a method executed by an electronic device according to an embodiment;

FIG. 2 is a schematic diagram of a multi-modal image retrieval method according to an embodiment;

FIG. 3 is a schematic diagram of a method of predicting two retrieval instructions according to an embodiment;

FIG. 4 is a schematic diagram of a method of predicting a first texture feature according to an embodiment;

FIG. 5 is a schematic diagram of a method of predicting a first semantic feature and a second heat map according to an embodiment;

FIG. 6 is a schematic diagram of an execution process of a multi-head attention network according to an embodiment;

FIG. 7 is a schematic diagram of a method of extracting a text feature according to an embodiment;

FIG. 8 is a schematic diagram of a method of extracting a text query feature according to an embodiment;

FIG. 9 is a schematic diagram of a method of optimizing an image feature token according to an embodiment;

FIG. 10 is a schematic diagram of a method of optimizing an image feature token group according to an embodiment;

FIG. 11 is a schematic flowchart of generating a visual query feature according to an embodiment;

FIG. 12 is a schematic diagram of visual query feature imagination based on a retrieval instruction according to an embodiment;

FIG. 13 is a schematic diagram of an image retrieval process according to an embodiment;

FIG. 14 is a schematic diagram of an application scenario of the image retrieval method according to an embodiment; and

FIG. 15 is a schematic structure diagram of an electronic device according to an embodiment.

### DETAILED DESCRIPTION

An embodiment described and the configurations shown in the drawings, are only examples of embodiments, and various modifications may be made without departing from the scope and spirit of the disclosure.

The terms and words used in the following description and claims are not limited to the bibliographical meanings, but, are used to enable a clear and consistent understanding. It should be apparent to those skilled in the art that the following descriptions of various embodiments are provided for illustration purpose and not for the purpose of limiting the disclosure.

It is to be understood that the singular forms “a”, “an” and “the” include plural referents unless the context clearly dictates otherwise. For example, reference to “a component surface” includes reference to one or more of such surfaces. When a component is said to be “connected” or “coupled” to the other component, the component can be directly connected or coupled to the other component, or it can mean that the component and the other component are connected through an intermediate element. In addition, “connected” or “coupled” as used herein may include wireless connection or wireless coupling.

The term “include” or “may include” refers to the existence of a corresponding disclosed function, operation or component which can be used in various embodiments and does not limit one or more additional functions, operations, or components. The terms such as “include” and/or “have” may be construed to denote a certain characteristic, number, step, operation, constituent element, component or a combination thereof, but may not be construed to exclude the existence of the addition of one or more other characteristics, numbers, steps, operations, constituent elements, components or combinations thereof.

The term “or” used in various embodiments includes any or all of combinations of listed words. For example, the expression “A or B” may include A, may include B, or may include both A and B. When describing multiple (two or more) items, if the relationship between multiple items is not explicitly limited, the multiple items can refer to one, many or all of the multiple items. For example, the description of “parameter A includes A1, A2 and A3” can be realized as parameter A includes A1 or A2 or A3, and it can also be realized as parameter A includes at least two of the three parameters A1, A2 and A3.

Unless otherwise indicated, all terms used herein, which include technical terminologies or scientific terminologies, have the same meaning as that understood by a person skilled in the art to which the disclosure belongs. Such terms as those defined in a dictionary are to be interpreted to have the meanings equal to the contextual meanings in the relevant field of art, and are not to be interpreted to have ideal or excessively formal meanings unless otherwise indicated.

At least some of the functions in the apparatus or electronic device provided in an embodiment may be implemented by an AI model. For example, at least one of a plurality of modules of the apparatus or electronic device may be implemented through the AI model. The functions associated with the AI can be performed through a non-volatile memory, a volatile memory, and a processor.

The processor may include one or more processors. At this time, the one or more processors may be processors such as a central processing unit (CPU), an application processor (AP), for example, or a pure graphics processing unit, such as a graphics processing unit (GPU), a visual processing unit (VPU), and/or an AI processor, such as a neural processing unit (NPU).

The one or more processors control the processing of input data according to predefined operating rules or artificial intelligence (AI) models stored in the non-volatile memory and the volatile memory. The predefined operating rules or AI models are provided by training or learning.

Here, providing, by learning, refers to obtaining the predefined operating rules or AI models having a characteristic by applying a learning algorithm to a plurality of learning data. The learning may be performed in the apparatus or electronic device itself in which the AI according to an embodiment is performed, and/or may be implemented by a separate server/system.

The AI models may include a plurality of neural network layers. Each layer has a plurality of weight values. Each layer performs the neural network computation by computation between the input data of that layer (e.g., the computation results of the previous layer and/or the input data of the AI models) and the plurality of weight values of the current layer. Examples of neural networks include, but are not limited to, a convolutional neural network (CNN), a deep neural network (DNN), a recurrent neural network (RNN), a restricted Boltzmann machine (RBM), a deep belief network (DBN), a bi-directional recurrent deep neural network (BRDNN), generative adversarial networks (GANs), and deep Q-networks.

The learning algorithm is a method of training a predetermined target apparatus (e. g., a robot) by using a plurality of learning data to enable, allow, or control the target apparatus to make a determination or prediction. Examples of the learning algorithm include, but are not limited to, supervised learning, unsupervised learning, semi-supervised learning, or reinforcement learning.

The method provided may relate to one or more of technical fields such as speech, language, image, video, and data intelligence.

A method for recognizing a user's speech and parsing the user's intention may receive a speech signal as an analog signal via an acquisition device (e.g., a microphone) and may use an automatic speech recognition (ASR) model to convert the speech into computer-readable text. The user's intention may be obtained by using the text interpreted and converted through a natural language understanding (NLU) model. The ASR model or the NLU model may be an AI model. The AI model may be processed by an AI-processor designed in the hardware structure for processing the AI model. The AI model may be obtained by training. Here, “obtained by training” means that predefined operating rules or AI models configured to perform features (or purposes) are obtained by training an AI model with multiple pieces of training data by training algorithms. Language understanding is a technology for recognizing and applying/processing human language/text, for example, including natural language processing, machine translation, dialogue system, question and answer, or speech recognition/synthesis.

A method for image retrieval may obtain the output data for recognizing an image or features, regions, instructions, tokens, and the like in the image by using image data as input data of an AI model. The AI model may be obtained by training. Here, “obtained by training” means that predefined operating rules or AI models configured to perform features (or purposes) are obtained by training an AI model with multiple pieces of training data by training algorithms. The method may relate to the visual understanding field of the AI technology. Visual understanding is a technology for recognizing and processing objects like human vision, including, for example, object recognition, object tracking, image retrieval, human recognition, scene recognition, 3D reconstruction/positioning, or image enhancement.

A method for inferring or predicting features, regions, instructions and tokens may be recommended or executed by using image data and or text data through an AI model. The processor of the electronic device may preprocess data to convert the data into a form for use as an input to the AI model. The AI model may be obtained by training. Here, “obtained by training” means that predefined operating rules or AI models configured to perform features (or purposes) are obtained by training an AI model with multiple pieces of training data by training algorithms. Inference prediction is a technology for performing logic inference and prediction by using the determined information, including, for example, knowledge-based inference, optimized prediction, preference-based planning, or recommendation.

To make the objectives, technical schemes and advantages clearer, the implementations will be further described below in detail with reference to the drawings.

Existing technologies may be deficient in the accuracy of retrieval. Since the existing image retrieval methods extract high-dimension semantic features (e.g., “dog”) of reference image, and similar objects or objects of the same class often have similar high-dimension semantic features, it is difficult to distinguish or locate objects only by relying on such features. For example, it may be difficult to accurately search for a person, animal, object or the like (for example, intending to retrieve “photos of dog A”, but it instead retrieving “photos of dog B”). In the existing image retrieval methods, the whole reference image input by the user is input into a visual encoder, and the visual encoder can extract the global semantic feature of the whole image. The extracted feature is the remarkable global semantic feature (including “person, bag, sea, skirt”, for example) in the image, but does not focus on the user's region (e.g., “skirt”) of interest, resulting in interference from irrelevant features from other regions, so that the image retrieval result cannot be in line with the user's actual intention.

In view of the above, the disclosure provides a method that may be executed by an electronic device, an electronic device, a storage medium, and a program product. The disclosure further provides an image retrieval method or a multi-modal image retrieval method, which “imagines” the key features of the target image expected to find by the user according to the first text and the first image input by the user. According to these “imagined” feature expressions, the target image in the candidate image set can be located accurately and quickly.

The technical solution of an embodiment and the technical effects produced by the technical solution of an embodiment will be described by referring to some embodiments. It should be noticed that the following embodiments can be referred to, learned from or combined with each other, and the same terms, similar characteristics and similar implementation operations may be applied to different embodiments.

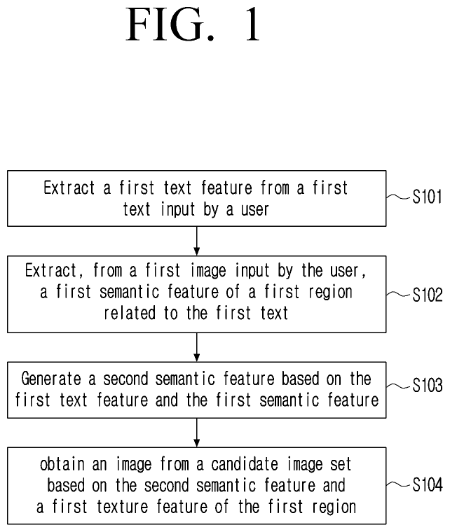

An embodiment provides a method executed by an electronic device. As shown in FIG. 1, the method includes the following.

In operation S101, a first text feature is extracted from a first text input by a user.

The first text may also be referred to as a retrieval text, which is used to find or locate the target image of the described content from a large number of images by using a natural language. The first text may be generated based on the characters directly input by the user, or may be generated based on the user's selection operation to displayed character options, or may be obtained by converting the speech input by the user, for example The input mode of the first text will not be limited in an embodiment.

The text feature may be extracted via a text encoder or in other ways. For example, the text feature is extracted in combination with the semantics of the first image or the first region. This will not be limited in an embodiment. The extracted text feature may also be referred to as the text feature token or text query feature.

In operation S102, a first semantic feature of a first region related to the first text is extracted from a first image input by the user.

The first image may also be referred to as the reference image, and can provide additional visual information for reference in image retrieval to improve the accuracy of image retrieval. The first image may be photographed in real time by the user, or may be selected from the photo album, or may be received from the network or other devices by the user, for example. The input mode and source of the first image are not limited.

Considering the growth of the user's photos, it may be difficult for the user to find the image through a single input (e.g., text). For example, if the user wants to search for “my photos of traveling to seaside with my favorite bag”, there may be many corresponding “photos of bags”, so it is difficult to determine which photo is the “photo of my favorite bag”. In an embodiment, this difficulty may be solved by multi-modal image retrieval. The user may provide the first image and the first text for image retrieval to perform multi-modal image retrieval. For example, the user provides the “photo of my favorite bag” as the first image to search the image corresponding to the first text “my photos of traveling to seaside with my favorite bag”, so that the image can be directly searched.

In an embodiment, the first region related to the first text in the first image refers to the object or region concerned or interested by the user, or the object or region that the user expects or wants to refer to in the first image that can be determined according to the user's intention corresponding to the first text. It should be understood that the first region and the first object can have similar meanings. As an example, if the first text input by the user is “wear this long skirt on the grass” and a first image including the “photo taken at the seaside, with wearing the long skirt, carrying the bag and holding the dog” is provided, the first region related to the first text in the first image refers to the “long skirt region” (or the object “long skirt”).

In an embodiment, the first region may be indicated in various ways. As an example, the first region may be indicated by the feature of the first region, a segmentation map, a weight map, a heat map, a mask, a text description, a related instruction or the like. This is not limited.

The first semantic feature may refer to a high-dimension feature, and the high-dimension feature can represent the semantic information of the object in the first region. The high-dimension feature may also be referred to as the high-dimension semantic feature or high-dimension visual semantic feature. The high-dimension features can pass through more network layers than low-dimension features. The first semantic feature can be extracted via a visual decoder, or by a new high-dimension feature extraction network or the like. This is not limited.

In an embodiment, according to the user's intention, only the region (e.g., the first region) concerned by the user may be extracted, and the first semantic feature of the first region may be focused, without the global semantic feature of the whole first image.

In operation S103, a second semantic feature is generated based on the first text feature and the first semantic feature.

In an embodiment, the second semantic feature may be understood as the visual query feature which is “imagined” according to the user's intention and can express the target image. This feature is generated from the first text feature and the first semantic feature, and this feature accurately describes the partial region that the user wants to refer to. Since there is no interference from other irrelevant region features, the generated feature is more accurate.

In operation S104, image retrieval is performed in a candidate image set based on the second semantic feature and a first texture feature of the first region.

The first texture feature may refer to a low-dimension feature. The low-dimension feature can represent the texture information of the object in the first region to better express the details of the object in the first region, wherein the texture information can reflect the uneven grooves presented on the surface of the object, such as boundaries, contours and patterns. The low-dimension feature may also be referred to as the low-dimension texture feature or low-dimension visual texture feature. The first texture feature can be extracted by using first several layers of the visual encoder, or by a new low-dimension feature extraction network or the like. This is not limited.

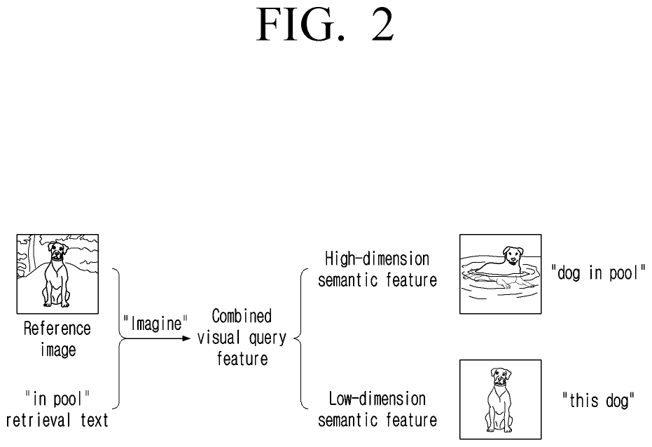

In an embodiment, both the first texture feature and the second semantic feature can be understood as the visual query features which are “imagined” according to the user's intention and can express the target image, and the combination of the both can be called the combined visual query feature group. As shown in FIG. 2, by taking the input first image being an image containing a dog and the input first text being “in pool” as an example, the feature group used for image retrieval includes two parts. One part is the second semantic feature (e.g., high-dimension semantic feature) that can depict the target image, for example, the feature of “dog in pool” in FIG. 2. This feature is generated from the text feature and the first semantic feature and accurately describes the partial region that the user wants to refer to. Since there is no interference from other irrelevant region features, the generated feature is more accurate. The other part is the first texture feature (e.g., low-dimension texture feature) of a part (e.g., the first region) in the first image reserved for expressing a particular object in the target image, for example, the feature of “this dog” in FIG. 2, e.g., the feature of white short fur or the like. This feature reserves the texture information of the first region, and can accurately and meticulously depict the object in the user's mind, so that the generated feature is more accurate. This combined visual query feature group is the feature expression for finding the target image, but not the RGB pixel of the actual image generated for observation, and can accurately and meticulously depict the target image in the user's mind. By obtaining an image based on this combined visual query feature group, the target image in the candidate image set may be located accurately and quickly.

In an embodiment, the obtaining the image or the image retrieval can also be referred to as image search or image query. The candidate image set is an image set of images to be retrieved by the user, such as a photo album, an e-commerce platform, a network search platform or the like. By giving the first image and the first text, the user may quickly and accurately find a target image from hundreds or thousands of images in the candidate image set, for example, through the above processing.

The distances between the features of images in the candidate image set and these features may be compared, and the candidate image corresponding to the feature with the closest distance may be used as the retrieval result. Other query methods may be used and are not limited.

In an embodiment, the second semantic feature is generated by “imagining” the key features of the target image that the user wants to find. According to these “imagined” feature expressions, the target image in the candidate image set may be located accurately and quickly. The texture information of the first region or the texture information similar to the first region is reserved to express an object in the first image, so the object in the user's mind can be depicted accurately and meticulously, so that the generated retrieval feature is more accurate, and the retrieval result is more in line with the user's actual intention.

In an embodiment, a second text feature corresponding to the first region and/or a third text feature corresponding to the target image may be determined based on the first image and the first text, wherein the second text feature is used for determining the first semantic feature and/or the first texture feature, and the third text feature is used for determining a third texture feature (which will be described hereinafter).

Considering that the first text input by the user may be concise and may focus on certain words, the user's actual intention may not be obtained only by the first text, and the first text input may be combined with the first image for co-inference. In an embodiment, the user's actual retrieval intention is predicted by multi-modal information fusing the first image and the first text, and the actual retrieval intention is further decoupled into a second text feature corresponding to the first region and/or a third text feature corresponding to the target image which are used for “imagining” visual query features.

A first retrieval instruction may be used to represent the second text feature corresponding to the first region to describe which regions may be reserved from the perspective of the text feature, and a second retrieval instruction may be used to represent the third text feature corresponding to the target image to describe which regions and the first text constitute the target image from the perspective of the text feature. For example, the user's actual retrieval intention may be decoupled into a first retrieval instruction and/or a second retrieval instruction which are used for “imagining” visual query features.

The first retrieval instruction can also be understood as a feature reservation instruction for indicating that the features of which regions may be reserved (e.g., “this dog” in the above example). Based on the guidance of the first retrieval instruction, the object of a particular region (e.g., the first region) in the first image may be kept unchanged to exact the low-dimension texture feature of this object into the first texture feature, for example, the feature of “this dog” in the above example, to retrieve the target image including this object.

The second retrieval instruction can also be understood as a feature planning instruction for indicating the feature to be planned (for example, the features such as “dog” and “in pool” in the above example can be enhanced, and other features can be weakened). Based on the guidance of the second retrieval instruction, the high-dimension semantic feature of the target image to be searched may be planned, for example, the feature of “dog in pool” in the above example, to retrieve the target image with similar semantics.

In an embodiment, an implementation is provided for the operation of “determining a second text feature corresponding to the first region and/or a third text feature corresponding to the target image based on the first image and the first text”. An embodiment may include the following.

In operation S201, a fourth semantic feature corresponding to the first image and at least one image feature token corresponding to the first image are determined, different image feature tokens indicating semantic features of different regions in the first image.

The token may also be referred to as a feature vector, and different image feature tokens represent feature vectors of different regions in the first image.

The first image and its semantic segmentation map may be used as the input of the visual encoder of the visual language model (for example, but not limited to, the vision transformer base resolution (ViT-B)/32 structure of the contrastive language-image pre-training (CLIP) model, the 512 channel, for example), and the fourth semantic feature and at least one image feature token are output. The fourth semantic feature can also be understood as the image global feature, which represents the remarkable feature of the whole image, for example, the feature related to “a dog in the grass” in the above example. The at least one image feature token can also be referred to as an image feature token group, wherein each token represents the feature of a different region and corresponds to a different object in the segmentation map, for example, “dog”, “grass” or the like in the above example. The image feature token group can also be understood as expressing the high-dimension semantic features of different regions in the first image.

In operation S202, at least one text feature token corresponding to the first text is determined.

The first text is input into the text encoder of the visual language model (for example, but not limited to, the VIT-B/32 structure of the CLIP model, the 512 channel, for example) to obtain the text feature token.

In operation S203, the second text feature and/or the third text feature is determined based on the at least one text feature token, the fourth semantic feature and the at least one image feature token.

In an embodiment, the user's actual intention is obtained based on the text feature token extracted from the first text and the fourth semantic feature and the image feature token group extracted from the first image, and this intention is decoupled to obtain the second text feature and/or the third text feature.

In an embodiment, an implementation is provided for operation S203. This implementation may include the following.

In operation S2031, a first feature is obtained based on the at least one text feature token and the fourth semantic feature via a fourth cross-attention network, the first feature including information related to the user's intention.

In an embodiment, cross-attention calculation is performed based on the at least one text feature token and the fourth semantic feature, with the purpose of interacting the remarkable visual information (e.g., the features such as “dog” and “grass” in the above example) with the information of the first text to obtain the most likely intention feature of the user (e.g., “dog in pool” in the above example). The feature that is more likely to be line with the user's intention corresponds to a higher weight.

In operation S2032, a second feature and a third feature are obtained based on the first feature and the at least one image feature token via a fifth cross-attention network, the second feature indicating a feature in the at least one image feature token that has a strong relationship with the first feature, the third feature indicating a feature in the at least one image feature token that has no relationship or a weak relationship with the first feature.

In an embodiment, cross-attention calculation is further performed on the first feature and the image feature token group, with the purpose of comparing the user's intention feature with the visual features of different regions in the first image, and estimating which visual features are likely to be similar (e.g., “dog”) to the user's intention (it can also be understood as which image feature tokens are more likely to be similar to those in the first feature) and which visual features are not likely to be similar (e.g., “grass”) to the user's intention (it can also be understood as which image feature tokens are more likely to be not similar to those in the first feature). The similar second feature is used for reservation or enhancement, and the non-similar third feature may be used for weakening.

In operation S2033, the second text feature and/or the third text feature is determined based on the second feature and the third feature.

The second text feature and/or the third text feature is decoupled based on the second feature via a first multilayer perceptron (MLP).

In an embodiment, an implementation is provided for operation S2031. This implementation may include the following.

In operation S301, a first query vector used for generating the second text feature and/or a second query vector used for generating the third text feature is acquired.

In an embodiment, instruction query features that can be learned in the network are set to represent the second text feature corresponding to the first region and/or the third text feature corresponding to the target image. For example, two instruction query vectors are set, for example, but not limited to, a query vector 1: reserving “XXX”, and a query vector 2: planning “XXX”.

The set instruction query feature has the same dimension as the text feature token. For example, at least one of the dimension of the first query vector and the dimension of the second query vector is the same as the dimension of the at least one text feature token.

In operation S302, a text fusion feature is obtained based on at least one of the first query vector and the second query vector, and the at least one text feature token via a self-attention network.

In an embodiment, the text feature token and the one or two query vectors are combined and then input to the self-attention network for text information fusion to obtain the text fusion feature.

In operation S303, the first feature is obtained based on the text fusion feature and the fourth semantic feature via the fourth cross-attention network.

In an embodiment, cross-attention calculation is performed based on the text fusion feature and the fourth semantic feature to interact the remarkable visual information with the text fusion feature to obtain the most likely intention feature of the user.

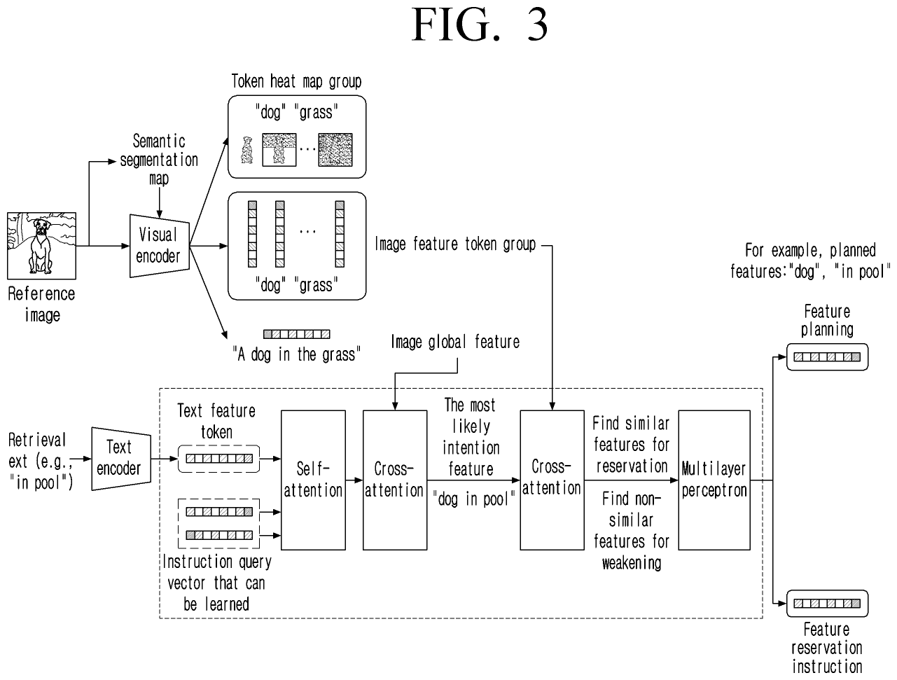

In an embodiment, a schematic diagram of a method of predicting two retrieval instructions is shown in FIG. 3. This method may include the following.

1) A reference image (a first image, e.g., a photo of “a dog in the grass”) and its semantic segmentation map are used as the input of a visual encoder of a visual language model, and an image global feature (a fourth semantic feature, including a remarkable feature of the whole image, e.g., a feature of “a dog in the grass”) and an image feature token group (at least one image feature token, where each image feature token group corresponds to the feature of the region where an object is located in the semantic segmentation map, e.g., “dog”, “grass”, for example) are output. A token heat map group (at least one heat map, where each heat map corresponds to one image feature token in the image feature token group and reflects the response intensity of this image feature in the reference image, and the usage of the token heat map group will be described hereinafter) may also be output.

2) A retrieval text (a first text, e.g., “in pool”) is input into a text encoder of the visual language model to obtain at least one text feature token.

3) The user's actual intention is estimate through the multi-modal interaction of the text information with the visual information. Two instruction query vectors (having the same dimension as the text feature token) that can be learned in the network are set to represent a feature reservation instruction (a second text feature corresponding to the first region) and a feature planning instruction (a third text feature corresponding to the target image). The text feature token and the two query vectors are combined and input to a self-attention network for text information fusion. Subsequently, cross-attention calculation is performed on the text fusion feature and the image global feature to interact the remarkable visual information (e.g., the feature of “dog”) with the text fusion feature to obtain the most likely intention feature (first feature) of the user, e.g., “dog in pool”. Cross-attention calculation is further performed on the user's intention feature and the image feature token group, the user's intention feature is compared with the visual feature of different regions, and a feature (second feature, e.g., “dog”) similar to the user's intention feature and a feature (third feature, e.g., “grass”) not similar to the user's intention in the visual features are estimated for planning, for example, reserving the similar feature and weakening the non-similar feature. Finally, the user's intention is decoupled into the feature reservation instruction and the feature planning instruction by a multilayer perceptron. The feature reservation instruction represents the features of which regions may be reserved (e.g., “this dog”), and the feature planning instruction represents the features to be planned (e.g., “dog”, “in pool”, for example).

In an embodiment, the first texture feature may also be extracted from the first region in the following way.

In operation S401, at least one first heat map corresponding to the first image is determined, different first heat maps corresponding to different regions in the first image, the different regions corresponding to different image feature tokens.

The first image and its semantic segmentation map may be used as the input of the visual encoder of the visual language model (for example, but not limited to, the VIT-B/32 structure of the CLIP model, the 512 channel, for example), and at least one first heat map is output, for example, together with the fourth semantic feature and the at least one image feature token. The at least one first heat map may also be referred to as a token heat map group, wherein each first heat map concerns a different region in the first image and corresponds to a different object in the segmentation map, or each first heat map may correspond to one image feature token in the image feature token group and reflect the response intensity of this image feature token in the reference image. For example, the method of extracting the at least one first heat map may be shown in FIG. 3.

In an embodiment, the heat map may also be replaced with other information indicating different regions, e.g., a weight map, a mask, for example Those skilled in the art can make extensions according to the actual situation, and these extensions shall be included in the protection scope.

In operation S402, a second heat map is obtained based on the second text feature corresponding to the first region and the at least one first heat map, the second heat map corresponding to the first region.

Since the second text feature can indicate the first region where the feature may be reserved, the heat map (for example, the second heat map) of the two-dimensional image level corresponding to the first region may be estimated according to the second text feature, so that it may be indicated which regions in the first image may be reserved. The second heat map may also be referred to as an image reservation heat map.

In operation S403, a second texture feature of the first image is extracted.

The second texture feature may refer to the global low-dimension feature of the first image. For example, the second texture feature may be extracted from the first image by using first several layers of the visual encoder or using a new low-dimension feature extraction network, but it is not limited thereto.

In operation S404, the first texture feature of the first region is obtained based on the second texture feature and the second heat map.

The second texture feature is multiplied with the second heat map to obtain the first texture feature of the first region, so that the low-dimension feature related to the object identity in the user's region of interest used for image retrieval can be reserved.

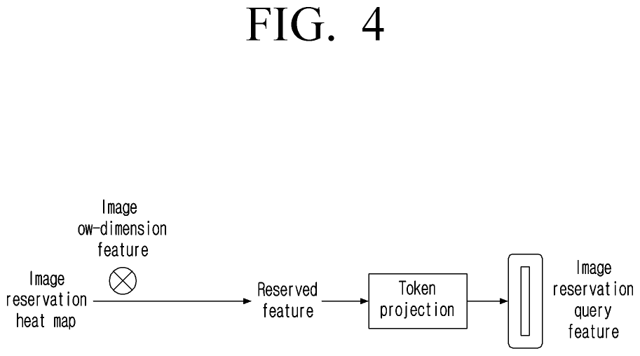

In one example, as shown in FIG. 4, the image reservation heat map (the second heat map) is multiplied with the low-dimension feature (the second texture feature) of the image, wherein the low-dimension feature may be the output after the first image passes through first several layers of the visual encoder; or, the two-dimensional feature (first texture feature) to be reserved in the first image may be obtained from the first image via a new convolutional neural network, for example, the output of first several layers of ResNet50.

In an embodiment, the reserved two-dimensional feature may be projected to a one-dimensional vector through a projection network. For example, the projection network may adopt (but not limited to) the attention pooling operation in the CLIP model obtain the one-dimensional first texture feature (corresponding to the image reservation query feature in FIG. 4), e.g., the one-dimensional low-dimension feature of “this dog” in the above example, so that the efficiency of feature comparison in image query can be improved.

In an embodiment, an implementation is provided for operation S402. This implementation may include the following.

In operation S4021, at least one image feature token corresponding to the first image is determined, different image feature tokens indicating features of different regions in the first image.

For implementation details relating to the method of determining at least one image feature token corresponding to the first image, reference may be made to the descriptions of operation S201.

In this step, the at least one image feature token determined in operation S201 may be directly obtained and used to simplify the processing process, or may also be determined again. This is not limited.

In operation S4022, a first attention result is obtained based on the at least one image feature token and the first text feature via a first cross-attention network, a first weight corresponding to the first attention result indicating the relationship between each image feature token and the user's intention.

In an embodiment, the image feature token group and the text feature token are subjected to cross-attention calculation, and the obtained first attention result can filter out the image feature token with a weak relationship with the user's intention, e.g., “grass” in the above example or the like.

The first weight corresponding to the first attention result may be the calculated similarity matrix in the processing process of the first cross-attention network. A smaller numerical value in the similarity matrix indicates that this image feature token is less correlated to the user's intention. For example, the relationship corresponding to the image feature token expressing “grass” in the above example is weaker. This calculation plays a role in filtering non-correlated image feature tokens. Based on the first weight and the at least one image feature token, the first attention result can be obtained.

In operation S4023, a second attention result is obtained based on the first attention result and the second text feature via a second cross-attention network, a second weight corresponding to the second attention result indicating the relationship between each image feature token and the second text feature.

In an embodiment, the first attention result and the second text feature are subjected to cross-attention calculation, and the obtained second attention result can be focused on the image feature token with a strong relationship with the second text feature, e.g., “dog” in the above example or the like.

The second weight corresponding to the second attention result may be the calculated similarity matrix in the processing process of the second cross-attention network. A larger numerical value in the similarity matrix indicates that this image feature token is close to the second text feature and may be likely to be the image feature token that is to be reserved, e.g., the image feature token expressing “dog” in the above example. In this step, the image feature token related to the region concerned by the user becomes more prominent and remarkable through the second text feature. Based on the second weight and the first attention result, the second attention result can be obtained.

In operation S4024, the at least one first heat map is fused based on the first weight and/or the second weight to obtain the second heat map.

In an embodiment, the second heat map (e.g., the image reservation heat map) may be obtained by performing weighted summation on the at least one first heat map by sharing the weight in the cross-attention calculation.

In an embodiment, an implementation is provided for operation S4024. This implementation may include the following.

In operation S501, the at least one first heat map is enhanced based on the first weight and/or the second weight to obtain at least one third heat map that is enhanced respectively.

In an embodiment, since each first heat map corresponds to one image feature token, the first heat map may share the similarity matrix (the first weight and/or the second weight) in the attention calculation of the image feature token.

The similarity matrix may be averaged in the token dimension direction to obtain the weighted value (in an amount the same as the number of the first heat maps) of each first heat map, and the at least one first heat map is weighted by the weighted value to enhance the first heat map.

The first weight and the second weight may be used to enhance the at least one first heat map at one time, respectively; or, the first weight and the second weight are fused to enhance the at least one first heat map at one time. This is not limited.

In operation S502, a third weight separately corresponding to the at least one image feature token is determined based on the second attention result.

In an embodiment, according to whether the image feature token belongs to the region concerned by the user, whether the image feature token may be reserved or the like, the calculated second attention result may be further subjected to weighted fusion by linear calculation. Since each first heat map corresponds to one image feature token, the first heat map may share the third weight in the linear calculation. The third weight may be obtained by training.

In operation S503, the at least one third heat map is fused based on the third weight to obtain the second heat map.

For example, the at least one third heat map may be weighted and summed based on the third weight to obtain the second heat map (the image reservation heat map) of the two-dimensional image level, which indicates which regions in the first image may be reserved.

In an embodiment, an implementation is provided for the operation of “extracting, from a first image input by the user, a first semantic feature of a first region related to the first text” in the operation S102. This implementation may include: fusing the at least one image feature token based on the third weight to obtain the first semantic feature.

In an embodiment, according to whether the image feature token belongs to the region concerned by the user, whether the image feature token may be reserved or the like, a plurality of high-dimension semantic features may be merged into one feature by linear calculation, and the first semantic feature that can represent the user's region of interest and may be reserved in the target image is finally obtained. The first semantic feature corresponds to the second heat map. Since the image feature token expresses the high-dimension semantic features of different regions in the first image, the first semantic feature may also be the high-dimension semantic feature to be reserved. The first semantic feature may also be referred to as the visual focus feature. For example, in the above example, the visual focus feature includes the feature related to “dog”.

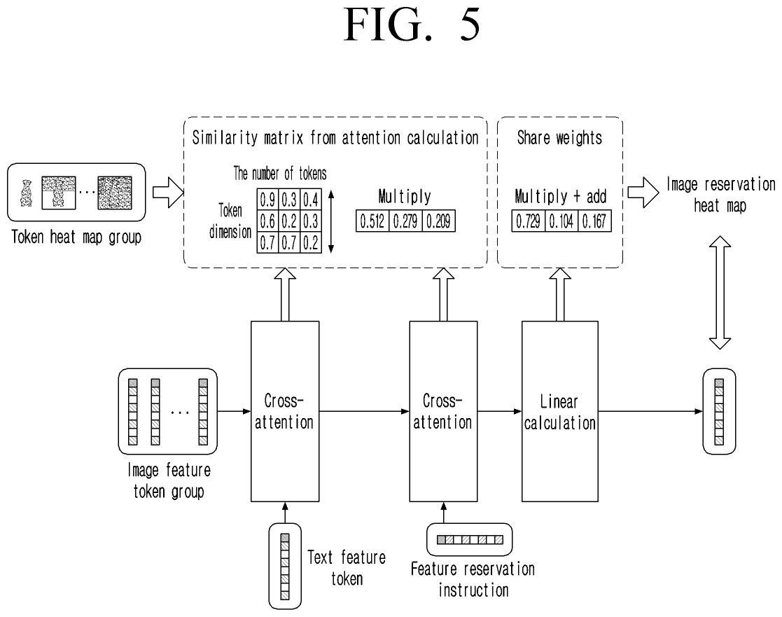

In an embodiment, a schematic diagram of a method of predicting the first semantic feature and the second heat map is shown in FIG. 5. This method may include the following.

1) The image feature token group (at least one image feature token) and the text feature token are subjected to cross-attention calculation. A smaller numerical value of the calculated similarity matrix (the first weight) indicates that this image feature token is less correlated to the user's intention. The first attention result is calculated based on the similarity matrix and the image feature token group. This calculation plays a role in filtering non-correlated image features, for example, less correlated features such as “grass” in the above example.

2) The first attention result and the feature reservation instruction (the second text feature corresponding to the first region) are subjected to cross-attention calculation. A larger numerical value in the calculated similarity matrix (the second weight) indicates that this image feature token is close to the feature reservation instruction and may be likely to be the feature to be reserved, e.g., the feature expressing “dog” in the above example. The second attention result is calculated based on the similarity matrix and the first attention result. In this step, the image feature token related to the region concerned by the user becomes more prominent and remarkable through the feature reservation instruction.

3) The second attention result is subjected to linear calculation. According to whether the image feature token belongs to the region concerned by the user, whether the image feature token may be reserved or the like, the second attention result is further subjected to weighted fusion. The visual focus feature (the first semantic feature) that can represent the user's region of interest and may be reserved in the target image is finally obtained. For example, in the above example, the feature related to “dog” may be reserved.

4) The image reservation heat map (the second heat map) corresponding to the visual focus feature is calculated. The input is the feature heat map group (at least one first heat map). Each feature heat map corresponds to one image feature token, and the feature heat map may share two similarity matrices in the attention calculation of the image feature token and the weight in the linear calculation. For each similarity matrix in the two similarity matrices, each token may be averaged to obtain the weighted value of each feature heat map to enhance each feature heat map. A number of enhanced feature heat maps are weighted and summed based on the weight shared by the linear calculation to obtain the image reservation heat map (the second heat map) of the two-dimensional image level corresponding to the visual focus feature.

In an embodiment, an implementation is provided for operation S103. This implementation may include the following.

In operation S601, a third semantic feature of the first region is obtained based on the first semantic feature and the third text feature corresponding to the target image.

The user may only want to search the target image related to a certain part of the first image, e.g., the pet, person or the like in the first image, while other objects such as background are meaningless and even interfere with the correct image retrieval process. Under the guidance of the second text feature, in an embodiment, only the first semantic feature of the region concerned by the user can be accurately extracted, and the second heat map corresponding to the region to be reserved in the first image is also obtained. The second heat map is used for the calculation of the first texture feature of the first region, and the first semantic feature is used for the calculation of the third semantic feature of the first region in combination with the third text feature corresponding to the target image.

The third semantic feature may also be referred to as the image planning query feature and may express the image feature of the target image, e.g., expressing the high-dimension semantic feature of “dog in pool” in the above example.

In operation S602, a second semantic feature is generated based on the first text feature and the third semantic feature.

As one simple method, the first text feature and the third semantic feature are summed to obtain the second semantic feature. It is not limited thereto, and other methods may be used. In an embodiment, an implementation is provided for operation S601. This implementation may include the following.

In operation S6011, a third attention result is obtained based on the first semantic feature and the third text feature via a third cross-attention network.

At least one head feature of the first semantic feature is interacted with the corresponding head feature of the first text feature via a multi-head attention network sharing the weight, to obtain at least one group of attention results; and, the at least one group of attention results is fused to obtain the third attention result.

In an embodiment, the first semantic feature he the third text feature corresponding to the target image are subjected to interactive calculation through a multi-head attention network sharing the weight, to finally obtain the third semantic feature of the first region.

The number of attention heads (the number of feature groups) in the multi-head attention network may be set according to the actual situation and is not limited.

In an embodiment, the multi-head attention network will perform attention interactive calculation on the first semantic feature and the third text feature, both of which consist of the same number of feature groups. An attention calculation may be performed on the feature groups with the same serial number to obtain multiple groups of attention results.

If a higher weight will be allocated to a certain feature group in the first semantic feature with stronger relationship with the third text feature and an opposite weight will be allocated to this feature group in the third text feature, this feature group in the first semantic feature will be transferred to the next step, and this feature group in the third text feature will be ignored. If a lower weight will be allocated to at least one feature group with weaker relationship with the third text feature and an opposite weight will be allocated to this feature group in the third text feature, this feature group in the third text feature will be transferred to the next step, and this feature group in the first semantic feature will be ignored.

In operation S6012, the third semantic feature of the first region is obtained based on the third attention result.

The third semantic feature of the first region is obtained based on the third attention result via a second multilayer perceptron.

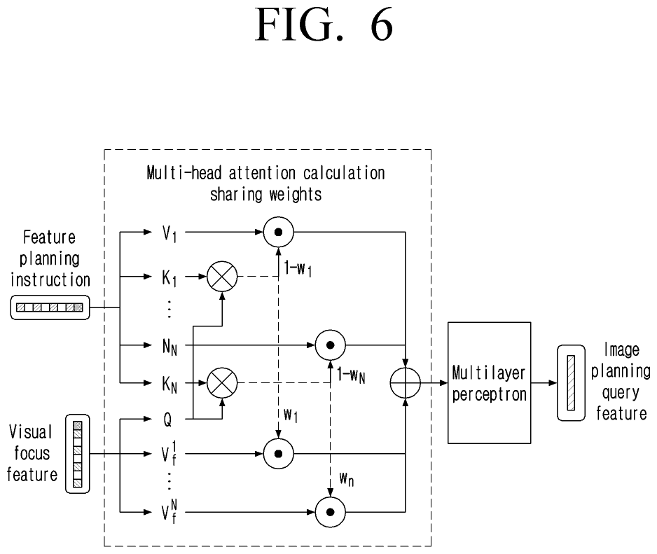

In one example, as shown in FIG. 6, the high-dimension semantic visual feature of the searched target image is planned according to the feature planning instruction (the third text feature corresponding to the target image) and the visual focus feature (the first semantic feature). The visual focus feature and the image planning instruction are subjected interactive calculation through a multi-head attention network sharing the weight, to finally obtain the image planning query feature (the third semantic feature), wherein the execution process of the multi-head attention network may include the following:

1) A query vector Q of the visual focus feature and value vectors

$${V}_{f}^{n} ,$$

(n∈Z(1, N)) of multiple heads are calculated, where N represents the number of multiple heads. For example, in the above example, the visual focus feature may include the feature of “this dog” to be reserved, so the value vectors

$${V}_{f}^{1} ∼ {V}_{f}^{N}$$

of multiple heads may all represent the features related to “this dog”.

2) The feature planning instruction is further decomposed into key vectors Kₙ and value vectors Vₙ of multiple heads, where n∈Z(1, N), and N represents the number of multiple heads. For example, in the above example, the features such as “dog” and “in pool” may be planned in the feature planning instruction, and the key vectors Kₙ and value vectors Vₙ of multiple heads may represent different planned features, respectively. As an example, K₁ and V₁ represent the features related to “dog”, and K_{N} and V_{N} represent the features related to “in pool”. It should be understood by those skilled in the art that, these meanings are only schematic descriptions and are not intended to limit the disclosure.

3) The similarity weights wₙ (dotted line) and 1−wₙ (hollow line) of Q and Kₙ are calculated, respectively, (where wₙ∈(0, 1)); and, Vₙ and

$${V}_{f}^{n}$$

are weighted by using these weights. As an example, both V₁ and

$${V}_{f}^{1}$$

represent the features related to “dog”, and the value of w₁ is larger (e.g., close to 1). The

$${V}_{f}^{1}$$

expressing “this dog” is dot-multiplied with w₁ and will be transferred to the next step, while the V₁ expressing “dog” is dot-multiplied with 1−w₁ and will be ignored. The V_{N} expressing “pool” and the 1−w_{N} expressing “this dog” represent different features, and the value of w_{N} is smaller (e.g., close to 0). The w_{N} expressing “pool” is dot-multiplied with 1−w_{N} and will be transferred to the next step, while the

$${V}_{f}^{N}$$

expressing “this dog” is dot-multiplied with w_{N} and will be ignored. Other feature groups may be deduced in the same manner.

4) The attention results of all groups are linked and input into the multilayer perceptron, and the image planning query feature is finally output, e.g., the high-dimension semantic feature expressing “dog in pool”.

In an embodiment, an implementation is provided for operation S101. This implementation may include the following.

In operation S701, token projection is performed on the first semantic feature to obtain a second text.

Performing token projection on the first semantic feature is equivalent to abstracting the first semantic feature into text-like pseudo tokens to obtain the second text.

In operation S702, the text feature is obtained based on the first text and the second text via a text encoder.

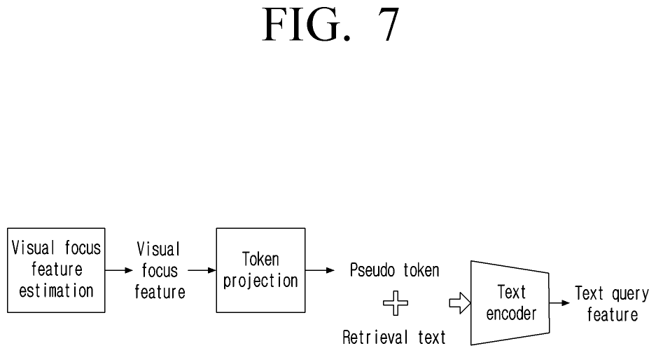

The method of extracting the text feature may be shown in FIG. 7. Based on the method in the above at least one embodiment, visual focus feature estimation is performed to obtain the visual focus feature (the first semantic feature), the visual focus feature is projected into pseudo tokens (the second text), and the text query feature is further generated in combination with the retrieval text (the first text) via the text encoder.

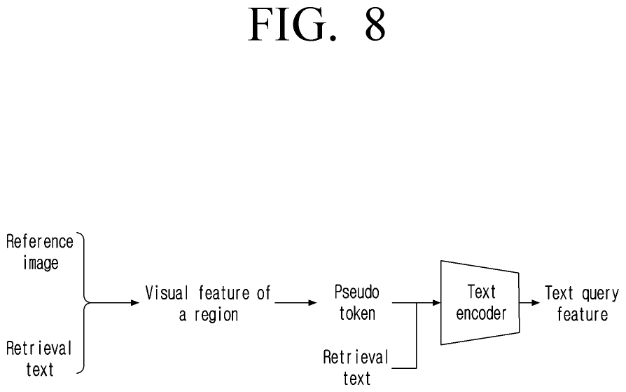

In an embodiment, as shown in FIG. 8, since the first semantic feature is extracted according to the user's input via the high-dimension semantic feature of the first region in the first image but not the global feature of the whole first image, the first semantic feature only includes the visual feature of a certain region. For example, if the input reference image (the first image) is the photo of “a dog in the grass” and the input retrieval text (the first text) is “in pool”, the determined first semantic feature is only the feature related to “dog”, and the abstracted second text is also only the pseudo tokens related to “dog”. The first text and the second text are processed by the text encoder, and the text query feature is output, e.g., the feature of “dog in pool”.

In an embodiment, in the process of generating the text query feature, the visual information of the most correlated region of the first image represented by the visual focus feature is injected into the text query feature, and the feature of the referenced first image is accurate without irrelevant information, so that the image retrieval result can be more in line with the user's intention.

In an embodiment, an implementation is provided for operation S4021. This implementation may include the following.

In operation S801, at least one first image feature token corresponding to the first image is determined.

For implementation details relating to the method of determining at least one first image feature token corresponding to the first image, reference may be made to the descriptions of operation S201.

In this step, the at least one image feature token determined in operation S201 may be directly obtained and used to simplify the processing process, or may also be determined again. This will not be limited in an embodiment.

In operation S802, at least one second image feature token corresponding to at least one second image is determined.

In an embodiment, the at least one second image can also be understood as the auxiliary image for optimizing the image feature token group. For implementation details of the method of determining the at least one second image feature token, reference may be made to the descriptions of determining the at least one first image feature token.

A clustering operation may be performed in the candidate image set based on the first image to obtain at least one second image. For example, the auxiliary image may be automatically obtained by an object clustering algorithm. The candidate image set used for determining the auxiliary image may be the same as or different from the candidate image set used for image retrieval.

At least one second image may be obtained based on the user's first designation operation. For example, the auxiliary image may be manually designated by the user.

In operation S803, the at least one first image feature token is processed based on the at least one second image feature token to obtain at least one image feature token corresponding to the first image.

In an embodiment, the image feature token group is further optimized by using the information provided by other auxiliary images. If there is an object similar to or the same as the reference image in the auxiliary image, the optimized image feature token is more advantageous for accurate and stable image retrieval.

In an embodiment, an implementation is provided for operation S803. This implementation may include the following.

In operation S8031, the relationship between the at least one first image feature token and the at least one second image feature token is determined to obtain first relationship information.

The relationship between one first image feature token of the first image and one second image feature token of one second image may be obtained by calculating the cosine distance therebetween (the two image feature tokens may be two vectors). A strong relationship indicates that two image feature tokens are very likely to express the same object.

The first relationship information between the image feature token groups of the first image and one second image may be efficiently calculated in the form of a matrix. For example, the first relationship information may be expressed as a similarity matrix Ta.

In operation S8032, at least one text feature token corresponding to the first text is determined, and the relationship between the at least one text feature token and the at least one second image feature token is determined to obtain second relationship information.

The relationship result may be stored in the form of a vector. For example, the second relationship information may be expressed as a similarity vector Va. A strong relationship indicates that the image feature of the second image can be well matched with the meaning described by the first text.

In operation S8033, the at least one first image feature token is processed based on the first relationship information, the second relationship information and the at least one second image feature token to obtain at least one processed image feature token corresponding to the first image.

The following may be adopted: attention calculation, multilayer perceptron, linear calculation, weighted summation or the like. However, the disclosure is not limited thereto. According to the calculated first relationship information and second relationship information, the second image feature token group of the auxiliary image is combined into the first image feature token group of the first image, so that the process of enhancing and optimizing the first image feature token group of the first image is completed by using the related visual information of the auxiliary image.

In one example, the calculation method of weighted summation may include the following: fusing the first relationship information and the second relationship information to obtain a fused weight; weighting the at least one second image feature token based on the fused weight to obtain at least one third image feature token; and, fusing the at least one third image feature token and the at least one first image feature token.

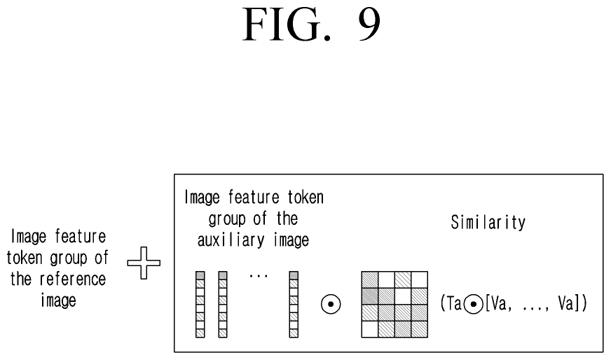

As an example, as shown in FIG. 9, the similarity vector Va (the second relationship information) is superimposed into a matrix along the number method of image feature tokens of the reference image (the first image), is then dot-multiplied with the similarity vector Ta (the second relationship information) to obtain the fused weight as the weighted value of each second image feature token of the auxiliary image (the second image), and is weighted (dot-multiplied) with the corresponding second image feature token and then added with the first image feature token group of the original reference image to obtain the final optimized image feature token group.

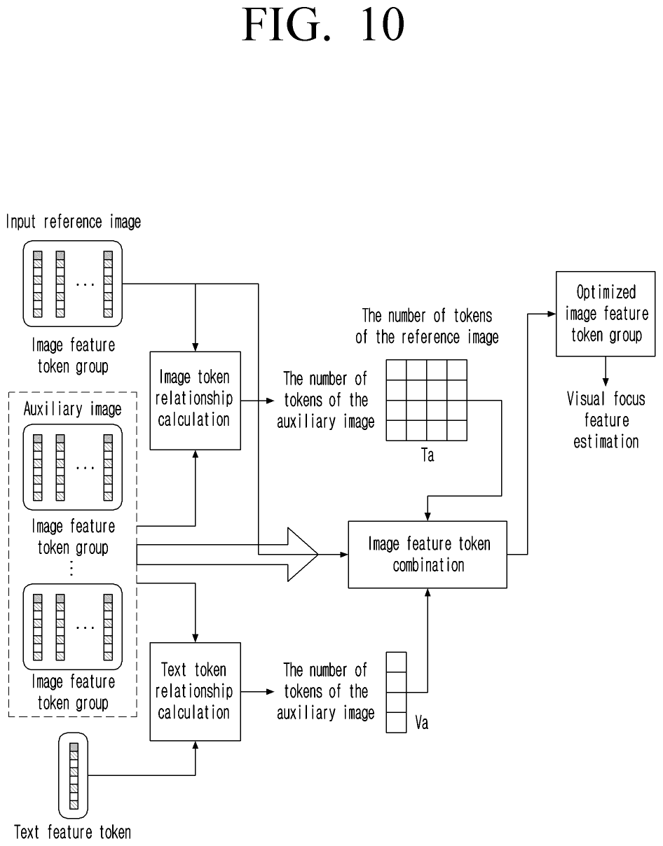

In an embodiment, a schematic diagram of a method of optimizing the image feature token group is shown in FIG. 10. This method may include the following.

1) Image token relationship calculation: the relationship between the image feature token group of the reference image (the first image) and the image feature token group of the auxiliary image (the second image) is calculated. The relationship between one image feature token of the reference image and one image feature token of the auxiliary image is calculated to obtain a similarity matrix Ta (first relationship information). A strong relationship indicates that the two image feature tokens are very likely to express the same object. Two dimensions of Ta represent the number of image feature tokens of the reference signal and the number of image feature tokens of the auxiliary image, respectively.

2) Text token relationship calculation: the relationship between the image feature token group of the auxiliary image and the text feature token of the retrieval text (the first text) is calculated to obtain a similarity vector Va (second relationship information). A strong relationship indicates that the image feature of the auxiliary image can be well matched with the meaning described by the retrieval text. The dimension of Va represents the number of image feature tokens of the auxiliary image.

3) Image feature token combination: by attention calculation, multilayer perceptron, linear calculation, weighted summation or other methods, the image feature token group is combined into the image feature token group of the reference image according to the calculated relationship, so that the process of enhancing and optimizing the image feature token group of the reference image by using the related visual information of the auxiliary image is completed. The optimized image feature token group can be used for the visual focus feature estimation described above, but it is not limited thereto.

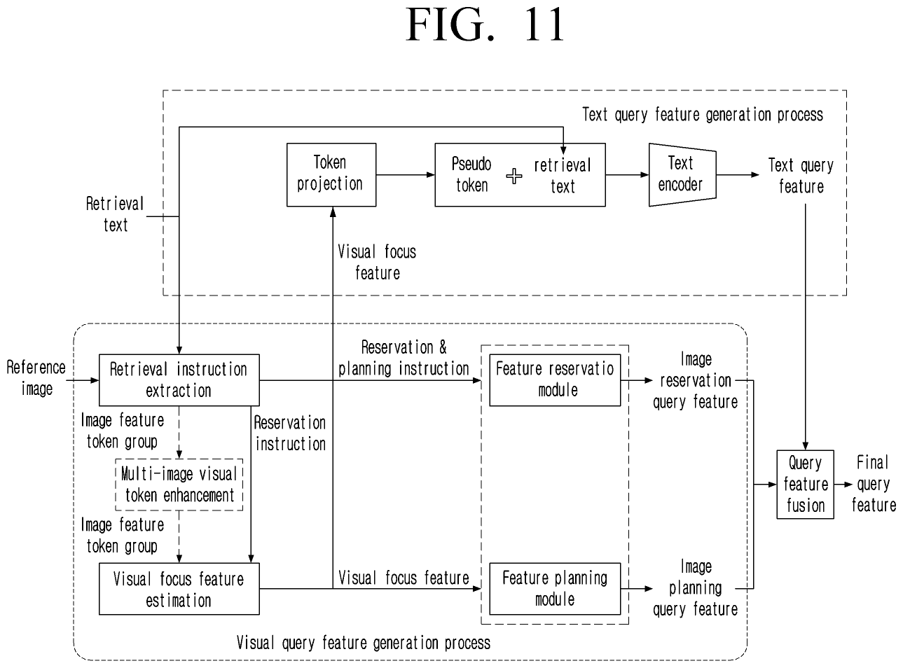

In an embodiment, a schematic diagram of a complete process of generating the visual query feature is shown in FIG. 11. This process may include the following.

In operation S11.1, the visual feature of the input reference image (the first image, e.g., the photo of “a dog in the grass”) and the input retrieval text (the first text) are fused. Two retrieval instructions (reservation & planning, respectively corresponding to the first retrieval instruction (the second text feature corresponding to the first region) and the second retrieval instruction (the third text feature corresponding to the target image)) are predicted, and the image feature token group (at least one image feature token) and its corresponding heat map group (at least one first heat map) are also obtained. This operation is completed by a retrieval instruction extraction module. For example, the reference can be made to the descriptions of FIG. 3.

In operation S11.2, the image feature token group is further optimized by using the information provided by other auxiliary images (second images). This operation is completed by a multi-image visual token enhancement module. For example, reference can be made to the descriptions of FIG. 9, FIG. 10 and the like.

In operation S11.3, the heat map (second heat map) and high-dimension semantic feature (data focus feature/first semantic feature) corresponding to the most correlated partial region (first region) in the reference image are estimated according to the feature reservation instruction. This operation is completed by a visual focus feature estimation module. For example, reference can be made to the description of FIG. 5 and the like.

In operation S11.4, under the guidance of the retrieval instruction, for the searched target image, the low-dimension image reservation query feature (first texture feature) is reserved, and the high-dimension image planning query feature (third semantic feature) is planned. This operation can be understood as the visual query feature imagination based on the retrieval instruction. This operation involves two modules, for example, a feature reservation module and a feature planning module. For example, the reference can be made to the descriptions of FIG. 4, FIG. 6, and the like.

In operation S11.5, the visual information of the most correlated region (first region) of the reference image represented by the visual focus feature is projected and then injected into the text query feature. For example, reference can be made to the descriptions of FIG. 7, FIG. 8, and the like.

In operation S11.6, finally, the text query feature and the two visual query features are fused to obtain the final query feature.

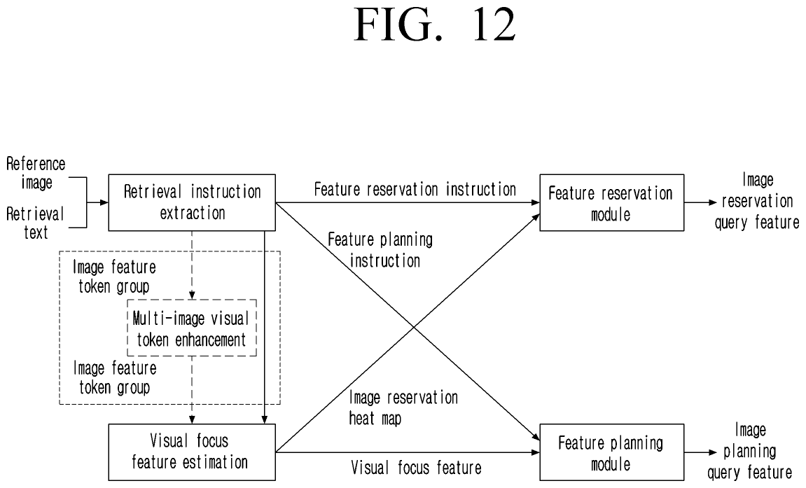

In the method of generating the visual query feature provided in an embodiment, as shown in FIG. 12, regarding the visual query feature imagination based on the retrieval instruction, the retrieval instruction extraction module predicts the feature reservation instruction and the feature planning instruction by fusing the visual feature of the input reference image and the information of the retrieval text. The image reservation query feature is generated via the feature reservation instruction, and the image planning query feature is generated via the feature planning instruction, thereby indicating the user's actual retrieval intention.

According to the visual information of auxiliary images with the same object in the candidate image set, the visual feature of the user's object of interest extracted from a particular region of the input reference image is enhanced for visual focus feature estimation. The enhanced feature is more advantageous for accurate and stable image retrieval.

Based on the guidance of the instruction and the image reservation heat map and visual focus feature obtained by visual focus feature estimation, the low-dimension texture feature of a particular region related to the object identity in the reference image is reserved, and the high-dimension semantic feature of the target image to be retrieved is planned. This combined visual query feature group accurately and meticulously depicts the target image in the user's mind.

As shown in FIG. 7, regarding the visual focus feature estimation of text query feature generation, based on the visual focus feature extracted by the visual focus feature estimation module, the text query feature is further generated by using this visual focus feature. Since this visual focus feature accurately depicts the partial region that the user wants to refer to and there is no interference from other irrelevant region features, the generated text query feature is more accurate, and the retrieval result is more in line with the user's actual intention.

In an embodiment, in order to determine the first region, another implementation is provided. The first region related to the first text may be determined in the first image based on the user's second designation operation. For example, the user may also designate the object to be retrieved in the reference image.

As an example, according to the semantic segmentation map of the first image, different regions in the first image may be generated into different options for selection by the user; and, the user may click any option to generate the second designation operation.

As another example, the user may circle a range in the first image to generate the second designation operation. The main object in this range corresponds to the first region.

It should be understood by those skilled in the art that the above designation methods are only schematic descriptions and do not constitute limitations to an embodiment, and appropriate alterations based on these examples are also within the scope of the disclosure.

In an embodiment, an implementation is provided for operation S104. This implementation may include: for each third image in the candidate image set, extracting a third texture feature and a fifth semantic feature of the third image; and, obtaining an image retrieval result based on a comparison result of the first texture feature and the third texture feature and/or a comparison result of the second semantic feature and the fifth semantic feature.

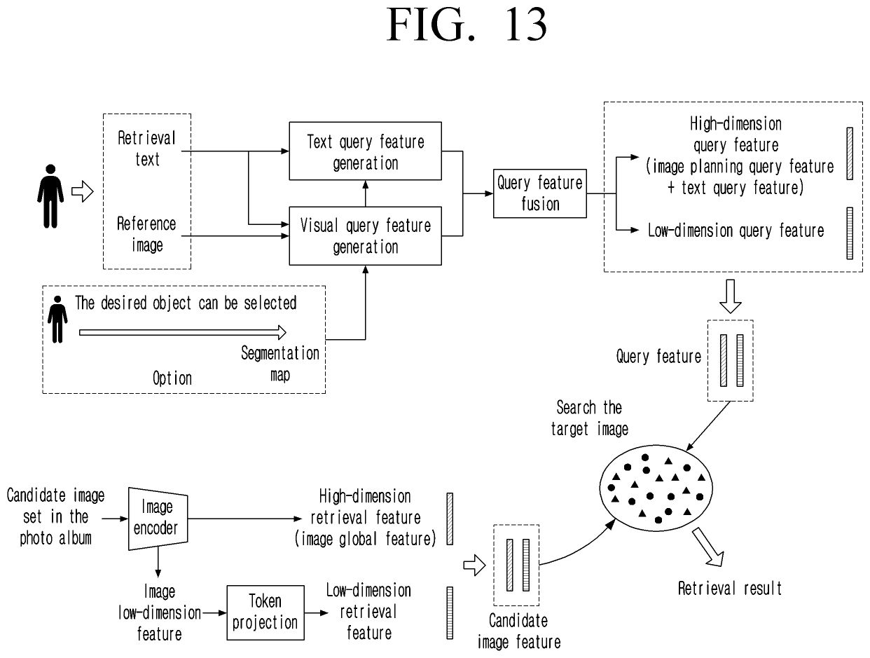

As an example, as shown in FIG. 13, the user inputs the reference image (first image) and the retrieval text (first text), and as options, the user may also designate the object to be retrieved in the reference image (for example, through the segmentation map). Three query features are generated by the text query feature generation process and the visual query feature generation process described in the above at least one embodiment, and the final query feature is generated by the query feature fusion module. The query feature includes two parts, one of which is the low-dimension query feature (for example, the image reservation query feature, corresponding to the first texture feature) and the other one of which is the high-dimension query feature (the second semantic feature, where one simple method is to sum the image planning query feature and the text query feature). For each image (third image) in the candidate image set of the photo album, the image high-dimension query feature (the image global feature, corresponding to the fifth semantic feature) and the image low-dimension feature (the output of first several layers of the image encoder, corresponding to the third texture feature) are obtained by an image decoder. The low-dimension feature is converted into a vector (for example, low-dimension query feature) through a token projection network. The low-dimension query feature and the high-dimension query feature are combined into the final candidate image feature. The query feature is compared with all candidate image features, and the image with the smallest vector distance is the retrieved target image.

Several scenarios where the image retrieval method provided in an embodiment can be used will be described below:

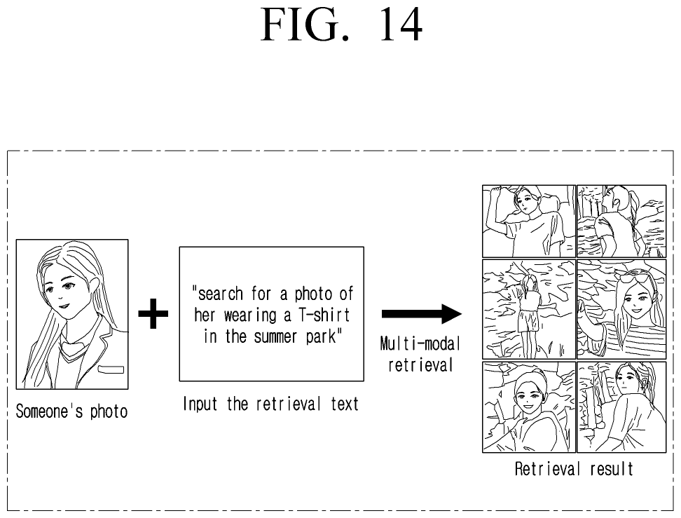

1) Searching a photo of a particular person/object: as shown in FIG. 14, the user may perform multi-modal retrieval by giving the reference photo (the first image, e.g., someone's photo) and inputting the retrieval text (the first text, e.g., “search for a photo of her wearing a T-shirt in the summer park”), and may quickly search the related photo of this person satisfying this condition from the photo album, to output the retrieval result.

2) Generating the photo album story of the user: the user may perform multi-modal retrieval by only giving the reference photo (the first image) and the theme text (the first text, e.g., “trip of someone and me”), and may actively generate the photo album story. The candidate photos satisfying the input theme text related to the reference image are searched by the image retrieval method provided in an embodiment, and these photos are further combined to generate the photo album story.

3) Searching photos of a particular object by using a plurality of reference photos: with reference to a plurality of auxiliary images and the input retrieval text, the user may quickly find the target photo in the photo album. Firstly, other candidate photos similar to the given reference photo (the first image, e.g., the photo of a certain building marker) are found by timestamp, clustering or other methods. The user can again filter, from these candidate photos, auxiliary images related to the reference image. These auxiliary images are used in combination with the reference image and the retrieval text (e.g., building surrounded by gorgeous fireworks in the night”) as inputs for multi-modal retrieval, so that the final search result is obtained.

Prototype verification experiments have been conducted on the public data set using the multi-modal image retrieval method provided in an embodiment. The experimental results show that the results of image retrieval using the combined feature are better than that of the existing image retrieval methods. It indicates that this image retrieval method which combines text and visual information can effectively enhance the query feature and realize higher accuracy of image retrieval.

The embodiments may be implemented with various electronic devices, including but not limited to, mobile terminals, intelligent terminals, smart phones, tablet computers, notebook computers, intelligent wearable devices (watches, glasses, for example), smart speakers, vehicle-mounted terminals, personal digital assistants, portable multimedia players, or navigation apparatuses, but the disclosure is not limited thereto. It should be understood by those skilled in the art that, except for the elements for mobile purpose, the configurations according to an embodiment can also be applied to a fixed type of terminals, such as digital TV sets or desktop computers.

The technical schemes provided in an embodiment can also be applied to image retrieval in servers, such as separate physical servers, which may be server clusters or distributed systems composed of a plurality of physical servers, or may be cloud servers that provide cloud computing services such as cloud services, cloud databases, cloud computing, cloud functions, cloud storage, network services, cloud communications, middleware services, domain name services, security services, content delivery networks (CDNs) and big data and artificial intelligent platforms.

An embodiment may further comprise an electronic device comprising a processor and, a transceiver and/or memory coupled to the processor configured to perform the operations of the method provided in any of the embodiments.

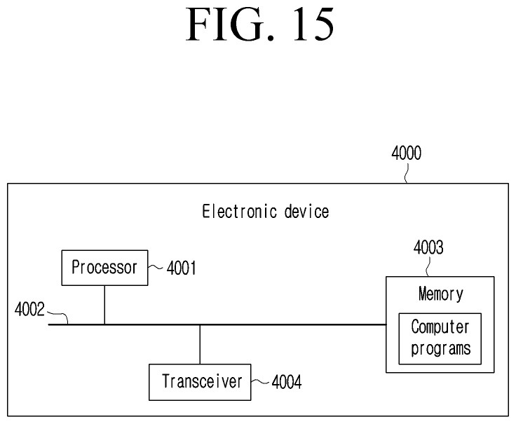

FIG. 15 shows a schematic structure diagram of an electronic device to which an embodiment is applied. As shown in FIG. 15, the electronic device 4000 shown in FIG. 15 may include a processor 4001 and a memory 4003. Wherein, the processor 4001 is connected to the memory 4003, for example, through a bus 4002. The electronic device 4000 may further include a transceiver 4004 that can be used for data exchange, for example, transmission and reception of data, between the electronic device and other electronic device. It should be noted that, in practical applications, the transceiver 4004 is not limited to one, and the structure of the electronic device 4000 does not constitute a limitation to an embodiment. The electronic device may be a first network node, a second network node or a third network node.

The processor 4001 may be a CPU (Central Processing Unit), a DSP (Digital Signal Processor), an ASIC (Application Specific Integrated Circuit), an FPGA (Field Programmable Gate Array) or other programmable logic devices, transistor logic devices, hardware components, or any combination thereof. The processor can implement or execute various exemplary logic blocks, modules and circuits described in the disclosure. The processor 4001 can also be a combination that implements computing functions, such as a combination of one or more microprocessors, a combination of a DSP and a microprocessor, and the like.

The bus 4002 may include a path to transfer information between the components described above. The bus 4002 may be a peripheral component interconnect (PCI) bus, or an extended industry standard architecture (EISA) bus, for example. The bus 4002 can be divided into an address bus, a data bus, a control bus, and the like. For ease of presentation, the bus is represented by only one thick line in FIG. 15. It does not mean that there is only one bus or one type of buses.

The memory 4003 may be a ROM (Read Only Memory) or other types of static storage devices that can store static information and instructions, a RAM (Random Access Memory) or other types of dynamic storage devices that can store information and instructions, and can also be EEPROM (Electrically Erasable Programmable Read Only Memory), CD-ROM (Compact Disc Read Only Memory) or other optical disk storage, compact disk storage (including compressed compact disc, laser disc, compact disc, digital versatile disc, or blue-ray disc, for example), magnetic disk storage media, other magnetic storage devices, or any other medium capable of carrying or storing computer programs and capable of being read by a computer, without limitation.

The memory 4003 is used for storing computer programs for executing an embodiment, and the execution is controlled by the processor 4001. The processor 4001 is used to execute the computer program stored in the memory 4003 to implement the solution provided in any method embodiment described above.

Embodiments provide a computer-readable storage medium having a computer program stored on the computer-readable storage medium, the computer program, when executed by a processor, implements the operations and corresponding contents of the foregoing method embodiments.

An embodiment further provides a computer program product, including computer programs that, when executed by a processor, can implement the operations and corresponding contents in the above method embodiments.

The terms “first”, “second”, “third”, “fourth”, “1”, “2”, for example (if present) and claims and the accompanying drawings above are used to distinguish similar objects and need not be used to describe a particular order or sequence. It is to be understood that the data so used are interchangeable under appropriate circumstances such that the embodiments described herein are capable of operation in other sequences than described or illustrated herein.

It should be understood that, although the operations are indicated by arrows in the flowcharts of the embodiments, the implementation order of these operations is not limited to the order indicated by the arrows. Unless otherwise explicitly stated herein, in some implementation scenarios, the operations in the flowcharts may be executed in other orders. Some, or all of the operations in each flowchart may include multiple sub-operations or multiple phases based on the actual implementation scenario. Some or all of these sub-operations or stages can be executed at the same moment, and each of these sub-operations or stages can also be executed at different moments separately. The order of execution of these sub-operations or stages can be flexibly configured according to requirements in different scenarios of execution time, and the embodiments are not limited thereto.

The above text and accompanying drawings are provided as examples only to assist the reader in understanding the disclosure. They are not intended and should not be construed as limiting the scope of the disclosure. Although certain embodiments and examples have been provided, based on what is disclosed herein, it will be apparent to those skilled in the art that the embodiments may be altered without departing from the scope of the disclosure. Employing other similar means of implementation also fall within the scope of the disclosure.

What is claimed is:

1. A method executed by an electronic device, comprising:
extracting a first text feature from a first text input by a user;
extracting, from a first image input by the user, a first semantic feature of a first region related to the first text;
generating a second semantic feature based on the first text feature and the first semantic feature; and
obtaining an image from a candidate image set based on the second semantic feature and a first texture feature of the first region.

2. The method according to claim 1, further comprising:
determining at least one first heat map corresponding to the first image, different first heat maps corresponding to different regions in the first image, the different regions corresponding to different image feature tokens;
obtaining a second heat map based on a second text feature corresponding to the first region and the at least one first heat map, the second heat map corresponding to the first region;
extracting a second texture feature of the first image; and
obtaining the first texture feature of the first region based on the second texture feature and the second heat map.

3. The method according to claim 2, wherein the obtaining the second heat map comprises:
determining a plurality of image feature tokens for the first image corresponding to a plurality of different regions in the first image;
obtaining a first attention result based on the plurality of image feature tokens and the first text feature via a first cross-attention network, a first weight of the first cross-attention network corresponding to the first attention result and indicating a first plurality of relationships between the plurality of image feature tokens and a user intent;
obtaining a second attention result based on the first attention result and the second text feature via a second cross-attention network, a second weight of the second cross-attention network corresponding to the second attention result and indicating a second plurality of relationships between the plurality of image feature tokens and the second text feature; and
fusing the at least one first heat map based on at least one from among the first weight and the second weight to obtain the second heat map.

4. The method according to claim 3, wherein the fusing the at least one first heat map comprises:
enhancing the at least one first heat map based on at least one of the first weight or the second weight to obtain at least one third heat map that is enhanced;
determining a plurality of weights corresponding to the plurality of image feature tokens based on the second attention result; and
fusing the at least one third heat map based on the plurality of weights to obtain the second heat map.

5. The method according to claim 4, wherein the extracting the first semantic feature comprises:
fusing the plurality of image feature tokens based on the plurality of weights to obtain the first semantic feature.

6. The method according to claim 1, wherein the generating the second semantic feature comprises:
obtaining a third semantic feature of the first region based on the first semantic feature and a third text feature corresponding to a target image; and
generating the second semantic feature based on the first text feature and the third semantic feature.

7. The method according to claim 6, wherein the obtaining the third semantic feature comprises:
obtaining a third attention result based on the first semantic feature and the third text feature via a third cross-attention network; and
obtaining the third semantic feature of the first region based on the third attention result.

8. The method according to claim 1, wherein the extracting the first text feature from the first text input comprises:
performing token projection on the first semantic feature to obtain a second text; and
obtaining the first text feature based on the first text and the second text via a text encoder.

9. The method according to claim 6, wherein at least one of the first semantic feature or the first texture feature are determined based on a second text feature corresponding to the first region, and
wherein the method further comprises determining at least one of the second text feature or the third text feature, based on the first image and the first text.

10. The method according to claim 9, wherein the determining the second text feature comprises:
determining a fourth semantic feature corresponding to the first image and at least one image feature token corresponding to the first image, different image feature tokens indicating semantic features of different regions in the first image;
determining at least one text feature token corresponding to the first text; and
determining the second text feature based on the at least one text feature token, the fourth semantic feature, and the at least one image feature token.

11. The method according to claim 10, wherein the determining the second text feature based on the at least one text feature token, the fourth semantic feature and the at least one image feature token comprises:
obtaining a first feature based on the at least one text feature token and the fourth semantic feature via a fourth cross-attention network, the first feature comprising user intent information;
obtaining a second feature and a third feature based on the first feature and the at least one image feature token via a fifth cross-attention network, the second feature being in the at least one image feature token and relating to the first feature, the third feature being in the at least one image feature token and not relating to the first feature or having a weaker relationship to the first feature than the second feature; and
determining the second text feature based on the second feature and the third feature.

12. The method according to claim 11, wherein the obtaining the first feature comprises:
acquiring at least one of a first query vector for generating the second text feature or a second query vector for generating the third text feature;
obtaining a text fusion feature via a self-attention network based on:
at least one of the first query vector or the second query vector, and
the at least one text feature token; and
obtaining the first feature based on the text fusion feature and the fourth semantic feature via the fourth cross-attention network.

13. The method according to claim 3, wherein the determining the plurality of image feature tokens comprises:
determining a first plurality of image feature tokens corresponding to the first image;
determining a second plurality of image feature tokens corresponding to a plurality of second images; and
processing the first plurality of image feature tokens based on the second plurality of image feature tokens to obtain the plurality of image feature tokens.

14. The method according to claim 13, wherein the processing the first plurality of image feature tokens comprises:
determining at least one first relationship between the first plurality of image feature tokens and the second plurality of image feature tokens;
determining at least one text feature token corresponding to the first text, and determining at least one second relationship between the at least one text feature token and the second plurality of image feature tokens; and
processing the first plurality of image feature tokens based on the at least one first relationship, the at least one second relationship, and the second plurality of image feature tokens to obtain a first plurality of processed image feature tokens corresponding to the first image.

15. An electronic device, comprising:
memory storing instructions; and,
at least one processor,
wherein the instructions, when executed by the at least one processor, cause the electronic device to:
extract a first text feature from a first text input by a user;
extract, from a first image input by the user, a first semantic feature of a first region related to the first text;
generate a second semantic feature based on the first text feature and the first semantic feature; and
obtaining an image from a candidate image set based on the second semantic feature and a first texture feature of the first region.

16. The electronic device according to claim 15, wherein the instructions, when executed by the at least one processor, cause the electronic device to:
determine at least one first heat map corresponding to the first image, different first heat maps corresponding to different regions in the first image, the different regions corresponding to different image feature tokens;
obtain a second heat map based on a second text feature corresponding to the first region and the at least one first heat map, the second heat map corresponding to the first region;
extract a second texture feature of the first image; and
obtain the first texture feature of the first region based on the second texture feature and the second heat map.

17. The electronic device according to claim 16, wherein the instructions, when executed by the at least one processor, cause the electronic device to:
determine a plurality of image feature tokens for the first image corresponding to a plurality of different regions in the first image;
obtain a first attention result based on the plurality of image feature tokens and the first text feature via a first cross-attention network, a first weight of the first cross-attention network corresponding to the first attention result and indicating a first plurality of relationships between the plurality of image feature tokens and a user intent;
obtain a second attention result based on the first attention result and the second text feature via a second cross-attention network, a second weight of the second cross-attention network corresponding to the second attention result and indicating a second plurality of relationships between the plurality of image feature tokens and the second text feature; and
fuse the at least one first heat map based on at least one from among the first weight and the second weight to obtain the second heat map.

18. The electronic device according to claim 17, wherein the instructions, when executed by the at least one processor, cause the electronic device to:
enhance the at least one first heat map based on at least one of the first weight or the second weight to obtain at least one third heat map that is enhanced;
determine a plurality of weights corresponding to the plurality of image feature tokens based on the second attention result; and
fuse the at least one third heat map based on the plurality of weights to obtain the second heat map.

19. The electronic device according to claim 18, wherein the instructions, when executed by the at least one processor, cause the electronic device to fuse the plurality of image feature tokens based on the plurality of weights to obtain the first semantic feature.

20. A non-transitory computer-readable recording medium having instructions recorded thereon, that, when executed by one or more processors, cause the one or more processors to:
extract a first text feature from a first text input by a user;
extract, from a first image input by the user, a first semantic feature of a first region related to the first text;
generate a second semantic feature based on the first text feature and the first semantic feature; and
obtaining an image from a candidate image set based on the second semantic feature and a first texture feature of the first region.
